(19) United States
(12) Patent Application Publication
(10) Pub. No.: US 2021/0264265 A1
(43) Pub. Date: Aug. 26, 2021

(54) METHOD FOR OPTIMALLY PROMOTING DECISIONS AND COMPUTER PROGRAM PRODUCT THEREOF

(71) Applicants: Taiwan Feibal Technology Corp., Taipei City (TW); Taiwan Data Science Co., Taipei City (TW)

(72) Inventors: Cheng-Chien HSU, Taipei City (TW); Chung-Tsen FAN CHIANG, Taipei City (TW); Ying-Chiang CHO, Taipei City (TW)

(73) Assignees: Taiwan Feibal Technology Corp., Taipei City (TW); Taiwan Data Science Co., Taipei City (TW)

(21) Appl. No.: 17/179,996

(22) Filed: Feb. 19, 2021

(30) Foreign Application Priority Data
Feb. 20, 2020 (TW) 109105558

(51) Int. Cl. G06N 3/08; G06N 7/00

(52) U.S. Cl. CPC G06N 3/08; G06N 7/005

(57) ABSTRACT

A method for optimally promoting decisions and a computer program product thereof are provided to perform a non-linear calculation by a computer to generate optimal information. The method for optimally promoting decisions includes: normalizing original data of a plurality of sources as a characteristic set; selecting a plurality of indicators from the characteristic set to form a decision set; receiving the decision set and determining whether the original data of the sources that corresponds to the indicators has a change, correspondingly adjusting a learning weight vector when it is determined that the change has occurred, and obtaining an optimal solution and a worst solution according to the learning weight vector and the decision set; and generating the optimal information according to the optimal solution and the worst solution. Accordingly, the optimal information can be quickly and accurately provided, as a reference for making decisions.

### CROSS-REFERENCE TO RELATED APPLICATION

This non-provisional application claims priority under 35 U.S.C. § 119(a) to Patent Application No. 109105558 filed in Taiwan, R.O.C. on Feb. 20, 2020, the entire contents of which are hereby incorporated by reference.

### BACKGROUND

### Technical Field

The present invention relates to a method for optimally promoting decisions and a computer program product thereof, and in particular, to providing optimal information for a decision maker or an investor by using big data and artificial intelligence technologies.

### Related Art

Each of us almost encounters a problem of making decisions every day, but we, especially investors (or decision makers), do not known what decisions are currently most suitable for ourselves or enterprises. Sometimes when investors or decision makers face dozens of indicators or choices, it is often very difficult for each of the dozens of indicators or choices to be oriented to the most desirable solution in mind. In most cases, some indicators have very good performance, but other indicators have very poor performance. In this way, people face a “trade-off” dilemma in the dozens of indicators or choices. Investment decisions in the financial field are used as an example for description below.

Currently, when facing a lot of information that is treacherous in the financial market every day, general investors or proficient and professional investors (including fund managers) generally rely on two types of software in the market, that is, tape reading software and a strategy back-testing system. The most obvious characteristic of the types of software is that statistics are collected on only historical data, and even more, statistical results are then presented to investors through data visualization.

The tape reading software is mainly to present real-time quotation information, such as a big board, stocks and a global financial market, and even historical price information. The former enables investors to know current real-time financial information, while the latter enables investors to look up an ups and downs status from the past to the present. However, such tape reading software is pure software that collects statistics on and visualizes data from the past to the present.

The strategy back-testing system is more complex than the tape reading software. Generally, strategy back-testing is providing investors with a setting of “stock selection conditions” for stocks, where “stock selection conditions” quite depend on a technical factor (for example, a technical line) and a chip factor (for example, shares held by three major legal persons). Therefore, the strategy back-testing system is regarded by the investors as a basis of “condition of operating a transaction”. However, the setting of the “stock selection conditions” of such a strategy back-testing system has several disadvantages as follows:

First, the past experience is required. The “stock selection conditions” are selected according to the past experience in stock price changes observed by investors, and are, for example, setting conditions such as stable price and reduced volume, a breakthrough of a (daily, monthly or quarterly) moving average and explosion of single-day stock trading volume. However, the past experience all depends on subjective determination of investors.

Second, a relationship between the market and a stock price change structure needs to be known. Professional investors need to spend a lot of time every day in knowing the relationship between the market and stock price changes, especially industry categories to which stocks belong are different, and even the business cycle is further involved. As a result, considerable research and professional knowledge are required to set technical indicators. All professional investors need to give a lot of care, let alone ordinary office workers or students who have no time to learn professional knowledge about investment and finance.

Third, how to set parameters is not known. It heavily relies on the past experience of the investors to set hard-to-understand statistics, for example, dozens of parameters such as MACD, RSI, 5-day moving average, 10-day moving average, Bollinger bands, DMI, KDJ, EMA, and ROC, and after the setting of the parameters, the parameters are then readjusted according to a historical back-tested profit margin. That is, the strategy back-testing system does not have the function of optimizing the parameters, so that the investors can only back-test a better profit model depending on luck and experience in thousands of permutations and combinations. In addition, it is impossible for general investors to have such professional knowledge of statistical indicators. Therefore, in fact, such a complex software setting does not really resolve the problem for general investors in use.

Fourth, not all statistical indicators may be used for the back-testing. In practice, if investors (even professional investors) select excessive indicators, a problem of over fitting may be caused. That is, because the excessive indicators may cause characteristics of specific indicators to be repeated, a back-testing result deviates severely. The current strategy back-testing system does not provide such an algorithm to resolve this problem. Therefore, during use, the investors still set stock selection conditions according to the past experience in a status that whether there is over fitting is unknown. It is conceivable that a probability of severe back-testing deviations is greatly increased.

The problems described above can be summarized as follows: First, simple descriptive statistics and data visualization are made only for the historical data; second, excessive hard-to-understand statistical indicators confuse the investors; and third, the investors set the stock selection conditions according to the past experience to perform the back-testing in the status that whether there is over fitting is unknown, thereby greatly increasing the probability of severe back-testing deviations.

In view of this, to resolve the foregoing problems, how to reduce a use threshold of the investors (or decision makers) for the strategy back-testing system, further absorb all complex and hard-to-understand statistical indicators by using artificial intelligence, optimally correct the deviated parameters every day along with the change of the market environment, and then present a simple and understandable result to the investors (or the decision makers) to make decisions, is an urgent problem to be resolved in the industry.

### SUMMARY

An embodiment of the present invention provides a method for optimally promoting decisions, to quickly and simply assist decision makers with highly accurate information in making optimal decisions through artificial intelligence. A non-linear calculation is performed by a computer to generate optimal information. After acquiring original data of a plurality of sources, the computer performs the non-linear calculation immediately, and the accuracy of the optimal information is improved. The method for optimally promoting decisions includes the following steps: normalizing the original data of the sources as a characteristic set; selecting a plurality of indicators from the characteristic set to form a decision set, where the decision set is one of factors affecting the efficiency of the non-linear calculation and the accuracy of the optimal information; receiving the decision set and determining whether the original data of the sources that corresponds to the indicators has a change; correspondingly adjusting a learning weight vector when it is determined that the change has occurred, and obtaining an optimal solution and a worst solution according to the learning weight vector and the decision set, where elements in the learning weight vector correspond to the indicators respectively and are substantially between 0 and 1, and a sum of the elements is 1; and generating the optimal information according to the optimal solution and the worst solution.

An embodiment of the present invention further provides a computer program product for optimally promoting decisions. After being used for performing a non-linear calculation, the computer program product generates optimal information, and the accuracy of the optimal information is improved. The computer program product includes: an original data acquisition module, acquiring original data of a plurality of sources; a normalization module, normalizing the original data of the sources as a characteristic set; a characteristic selection module, selecting a plurality of indicators from the characteristic set to form a decision set, where the decision set is one of factors affecting the efficiency of the non-linear calculation and the accuracy of the optimal information; a learning weight vector module, receiving the decision set and determining whether the original data of the sources that corresponds to the indicators has a change, correspondingly adjusting a learning weight vector when the change has occurred, and obtaining an optimal solution and a worst solution according to the learning weight vector and the decision set, where elements in the learning weight vector correspond to the indicators respectively and are substantially between 0 and 1, and a sum of the elements is 1; and an optimization module, generating the optimal information according to the optimal solution and the worst solution.

In the method for optimally promoting decisions and the computer program product thereof provided according to the embodiments of the present invention, by utilizing the optimal solution and the worst solution, the optimal information can be quickly obtained, and effects of reducing computing resources and a computing time are achieved. In addition, by automatically adjusting the learning weight vector, the correctness of the information can be objectively conveyed, and errors caused by past data can be corrected immediately, thereby improving analysis accuracy. That is, according to the present invention, after a non-linear optimization algorithm is made for a large amount of data through artificial intelligence, not only all to-be-decided items can be quantified, but also the accuracy of the optimal information can be really quickly and greatly improved.

### BRIEF DESCRIPTION OF THE DRAWINGS

FIG. 1 is a flowchart of a method for optimally promoting decisions according to an embodiment of the present invention;

FIG. 2 is a schematic diagram of a computer program product for optimally promoting decisions according to an embodiment of the present invention;

FIG. 3 is a schematic diagram of a computer program product for optimally promoting decisions according to another embodiment of the present invention; and

FIG. 4 is a schematic diagram presenting optimal information of all stocks in the Taiwan stock market according to an embodiment of the present invention.

### DETAILED DESCRIPTION

The content of the present invention is explained below through several embodiments and several drawings. However, the embodiments of the present invention and structural shapes and sizes shown in the drawings are merely used for explaining the present invention and are not intended to require that the present invention can be implemented only in any particular environment, application, or special manner described in the embodiments.

For ease of describing a method for optimally promoting decisions and a computer program product thereof in the present invention, how to assist people in making stock market investment decisions is used as an example for description below. However, it should be noted that, the present invention is not intended to limit the stock market investment decisions, and during implementation, can further extend to an investment decision of an enterprise decision maker on a significant investment such as expanding a plant or investing in specific technology development. In addition, according to the present invention, any decision on assisting an individual also falls within the scope of the present invention.

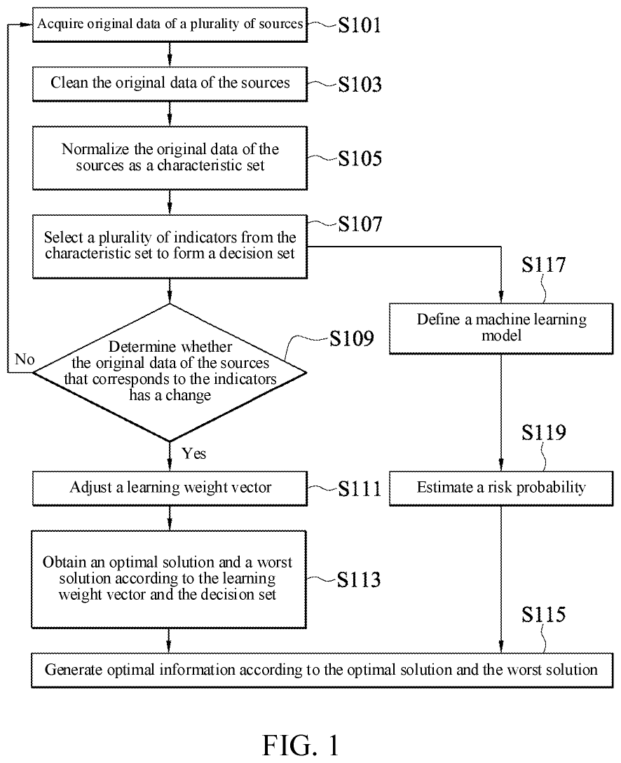

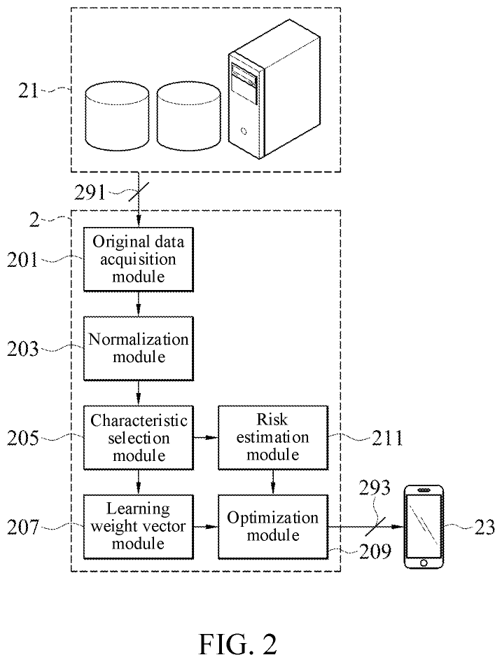

FIG. 1 is a flowchart of a method for optimally promoting decisions according to an embodiment of the present invention. In the method for optimally promoting decisions, a non-linear calculation is performed by a computer 21 (as shown in FIG. 2) to generate optimal information, where the computer 21 may be a computer and a server. After acquiring original data of a plurality of sources, the computer performs the non-linear calculation immediately, and the accuracy of the optimal information is improved. The method for optimally promoting decisions includes the following steps:

First, step S101: acquire original data of a plurality of sources, where the original data of the sources further includes at least one of structured data, unstructured data, and semi-structured data. The structured data refers to quantifiable information such as a closing price, a moving average convergence divergence (MACD) indicator, a relative strength index (RSI), a 5-day moving average, and an exponential moving average (EMA). The unstructured data refers to information that is difficult to quantify, such as text. The semi-structured data refers to data, for example, in an XML format.

Next, step S103: clean the original data of the sources. Because the original data received by the computer 21 may include missing values or other erroneous information, the missing values need to be interpolated or discarded in complex data through a program. In step S103, it is necessary to determine how to handle the missing values according to characteristics of the data and the domain knowledge.

Step S105: normalize the original data of the sources as a characteristic set S. The characteristic set S={X₁, X₂, X₃, X₄ . . . Xₚ₋₁, Xₚ|p∈N}, and N is a positive integer. When the present invention is implemented, X₁ may be an opening price, X₂ is a closing price, X₃ is MACD, X₄ is RSI, Xₚ₋₁ is capital stock, and Xₚ is an industry trend. Indicators and numbers in the characteristic set S above are merely used for illustration, and are not intended to limit the present invention.

Step S107: select a plurality of indicators from the characteristic set S to form a decision set D, where the decision set D is one of factors affecting the efficiency of the non-linear calculation and the accuracy of the optimal information. When step S107 is performed, through singular value decomposition (SVD) or principal component analysis (PCA), not only the number of indicators of the decision set D is reduced to reduce the amount of calculation, but also any two indicators are mutually orthogonal vectors. According to the embodiments of the present invention, after the decision set D in a certain period is calculated through SVD or PCA, D={X₁, X₂, X₃, X₄, Xₛ} p>5 and respectively corresponding to D={closing price, MACD, RSI, annual growth rate, industry trend}, where the industry trend may be semi-structured or unstructured data. One of the technical features of the present invention is that each indicator in the decision set D is a function of time. That is, the data of the closing price, the MACD, the RSI, the annual growth rate and the industry trend changes with time, and each indicator forms a time series vector. In addition, each indicator corresponds to a weight. For example, the closing price corresponds to a weight w₁, the MACD corresponds to a weight w₂, the RSI corresponds to a weight w₃, the annual growth rate corresponds to a weight w₄, and the industry trend corresponds to a weight w₅ to form a learning weight vector W=(w₁, w₂, w₃, w₄, wₛ). In this way, a person skilled in the art should understand that this falls within the scope of non-linear calculations, instead of simple mathematical deductions through which a person cannot calculate a result accurately, at any time, and quickly from a huge amount of complex data.

Step S109: receive the decision set D and determine whether the original data of the sources that corresponds to the indicators has a change. Specifically, when it is determined to be Yes, it represents that the change has occurred. In this case, step S111 is performed, that is, the learning weight vector W is correspondingly adjusted, and then step S113 is performed. Step S113: obtain an optimal solution A⁺ and a worst solution A⁻ according to the learning weight vector W and the decision set D, where elements in the learning weight vector W correspond to the indicators respectively and are substantially between 0 and 1, and a sum of the elements is 1. Otherwise, if it is determined to be No in step S109, the original optimal solution A⁺ and worst solution A⁻ of the adjusted learning weight vector W are maintained, and the process returns to step S101 to continuously monitor whether the original data of the sources has a new change.

One of the technical features of the present invention is to design the optimal solution A⁺ and the worst solution A⁻ to find the optimal information more accurately and quickly. Conventional arts all teach a concept of finding a local (or global) maximum or minimum solution in a space of linear algebra, and this concept is not a concept of the optimal solution A⁺ and the worst solution A⁻. An optimal solution corresponding to the optimal solution and the worst solution may be obtained by substituting the optimal solution A⁺ and the worst solution A⁻. According to the present invention, after the optimal solution A⁺ is obtained and the worst solution A⁻ in the space is correspondingly obtained, the optimal solution of the model can be quickly found. By contrast, a conventional neural network needs to perform repeated recursions, and a large amount of computing resources and time are spent in indirectly obtaining a better weight vector so as to obtain the optimal solution of the model. The calculation method of the optimal solution A⁺ and the worst solution A⁻ of the present invention is as follows:

$${A}^{+} = \{ [ {max}_{i} {v}_{ij} \text{\textbar} j ∈ J ] , [ {min}_{i} {v}_{ij} \text{\textbar} j ∈ {J}^{′} ] \text{\textbar} i = 1 , 2 , … , m \} = ( {v}_{1}^{+} , {v}_{2}^{+} , … , {v}_{j}^{+} , … , {v}_{n}^{+} )$$

$${A}^{-} = \{ [ {min}_{i} {v}_{ij} \text{\textbar} j ∈ J ] , [ {max}_{i} {v}_{ij} \text{\textbar} j ∈ {J}^{′} ] \text{\textbar} i = 1 , 2 , … , m \} = ( {v}_{1}^{-} , {v}_{2}^{-} , … , {v}_{j}^{-} , … , {v}_{n}^{-} )$$

$${v}_{ij} = \frac{{w}_{j} \times {x}_{ij}}{\sqrt{{\sum }_{i = 1}^{m} {x}_{ij}^{2}}} ,$$

x is an element of a time series vector corresponding to each indicator in the decision set D, and J is a benefit criterion, and represents that a higher performance score is better, such as the annual growth rate; J′ is a cost criterion, and represents that a lower performance score is better, such as the closing price; and wⱼ is an element of the learning weight vector W, and in this embodiment of the present invention, W=(w₁, w₂, w₃, w₄, wₛ). Furthermore, in this embodiment of the present invention, compared with a neural network, the optimal solution A⁺ is obtained by classifying X₁, X₂, X₄ as a set of the benefit criterion J and substituting it into a formula of vᵢⱼ, the worst solution A⁻ is obtained by classifying X₃, Xₛ as a set of the optimal solution A⁺ of the cost criterion J′ and substituting it into the formula of vᵢⱼ, and finally, a one-time overall operation is performed with reference to the worst solution A⁻ to quickly find the optimal learning weight vector W.

In the conventional art, regardless of whether in field of big data or artificial intelligence, processing for the weight is mostly set by subjective determination of a person or based on past experience in a field. In this way, during calculation, there is a very high probability in occurrence of severe errors to cause a decision maker to make improper decisions. However, in a process of step S111 to step S113, one of the technical features of the present invention is, for resolving the foregoing problems, to derive the learning weight vector W that may be automatically adjusted when the data has a change, to objectively convey the correctness of the information and immediately correct the errors of the past data.

The learning weight vector W is given according to distribution of the element xᵢⱼ included in the decision set D in the space. Specifically, a variation of each indicator may be measured indirectly through δⱼ, then the distribution of w₁ is determined, and a definition of δⱼ and the distribution of w₁ are as follows:

$${δ}_{j} = - {\sum }_{i = 1}^{m} \frac{{x}_{ij} \cdot ln ( \frac{{x}_{ij}}{{\sum }_{i = 1}^{m} {x}_{ij}} )}{{\sum }_{i = 1}^{m} {x}_{ij} ln ( m )} , \\ j = 1 , 2 , … , n \text{;} 0 \leq {δ}_{j} \leq 1 , \\ {w}_{j} = \frac{1 - {δ}_{j}}{{\sum }_{j = 1}^{n} ( 1 - {δ}_{j} )} , \\ j = 1 , 2 , … , n s . t . {\sum }_{j = 1}^{n} {w}_{j} = 1$$

In this embodiment of the present invention, wⱼ=w₁, w₂, w₃, w₄, w₅, and if wⱼ is substituted into vᵢⱼ, the optimal solution A⁺ and the worst solution A⁻ may be found. Finally, step S115: generate optimal information according to the optimal solution A⁺ and the worst solution A⁻, where the optimal solution A⁺ is a maximum benefit solution among several top-ranked solutions in the benefit criterion J found in a space of linear algebra, and the worst solution A⁻ is a minimum cost solution among several top-ranked solutions in the cost criterion J′ found in a space of linear algebra. The optimal information refers to the maximum benefit solution and the minimum cost solution.

In some embodiments, after step S107 in the present invention is performed, step S117 is further performed. A machine learning model is defined in response to characteristics of the decision set D, aiming to enter step S119 through the machine learning model, to estimate a risk probability, to estimate the risk probability more accurately, where the machine learning model is a mathematical model such as a Support Vector Machine (SVM), an artificial neural network (ANN), a Bayes' classifier, a Markov's chain, a hidden Markov model (HMM) or clustering.

FIG. 2 is a schematic diagram of a computer program product for optimally promoting decisions according to the present invention. After being loaded by the computer 21 to perform a non-linear calculation, the computer program product 2 generates optimal information 293, and the accuracy of the optimal information 293 is improved. The computer program product 2 includes modules such as an original data acquisition module 201, a normalization module 203, a characteristic selection module 205, a learning weight vector module 207, an optimization module 209, and a risk estimation module 211.

The original data acquisition module 201 is configured to acquire original data 291 of a plurality of sources that is stored in the computer 21. The normalization module 203 is configured to normalize the original data 291 from the original data acquisition module 201 as a characteristic set S. The characteristic selection module 205 is configured to select a plurality of indicators from the characteristic set S to form a decision set D, where the decision set D is one of factors affecting the efficiency of the non-linear calculation and the accuracy of the optimal information. The learning weight vector module 207 is configured to receive the decision set D and determine whether the original data 291 of the sources that corresponds to the indicators has a change, correspondingly adjust a learning weight vector W when the change has occurred, and obtain an optimal solution A⁺ and a worst solution A⁻ according to the learning weight vector W and the decision set D, where elements in the learning weight vector correspond to the indicators respectively and are substantially between 0 and 1, and a sum of the elements is 1. If the learning weight vector module 207 determines that the change has not occurred, the optimal solution A⁺ and the worst solution A⁻ obtained according to the learning weight vector are maintained. The optimization module 209 is configured to generate the optimal information 293 according to the optimal solution A⁺ and the worst solution A. The optimal information 293 may be displayed in the computer 21, or may be transmitted to another electronic device 23 (for example, a mobile device) through, for example, a network and displayed.

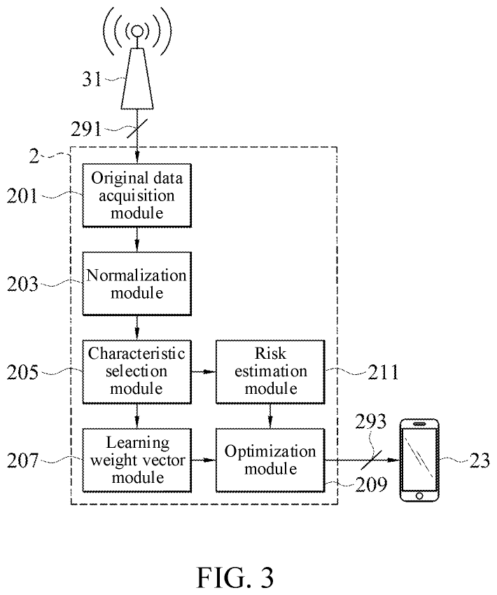

FIG. 3 is a schematic diagram of a computer program product for optimally promoting decisions according to another embodiment of the present invention. In this embodiment, the computer program product 2 for optimally promoting decisions is substantially the same as that in FIG. 2, and similarities are not described herein again. The only difference is that in this embodiment of the present invention, the original data 291 may be received from a wireless signal device 31.

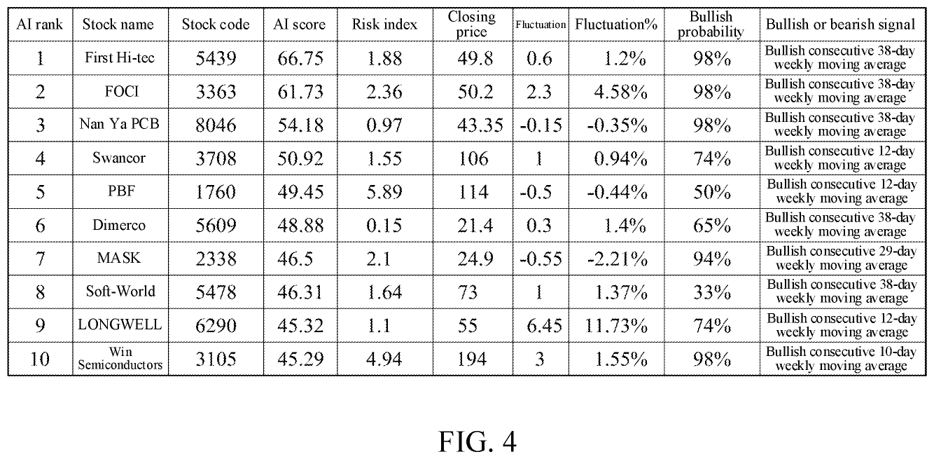

FIG. 4 is a schematic diagram presenting optimal information 293 of all stocks in the Taiwan stock market according to an embodiment of the present invention. The optimal information 293 mainly includes fields such as “AI rank”, “stock code”, “AI score”, “risk index”, “bullish probability”, and “bullish or bearish signal” that are ranked after an optimization calculation derived through the machine learning model of the present invention. For example, after a massive calculation is performed on an after-hour trading in a specific day for the original data 291 corresponding to nearly 1700 stocks included in Taiwan stock market through an optimally promoted decision, an “AI rank” of the nearly 1700 stocks and its corresponding information in the day can be obtained. For example, a stock code of the first of “AI rank” is “5439” in a specific day, its “AI score” is 66.75, its corresponding “risk index” is 1.88, its “bullish probability” of a future weekly moving average is 98%, and a “bullish or bearish signal” is a bullish consecutive 38-day weekly moving average, where the foregoing original data 291 includes all chip factors, technical factors, and industrial fundamental factors in the market.

Furthermore, if the “AI score” of a stock is greater than 60, and is even increased day by day, it represents that all or most of the information in the market is directed to bullishness, and therefore it represents that the stock is profitable.

In summary, unlike the conventional neural network with the problem that repeated recursions are required and a lot of computing resources and time are spent in obtaining the optimal solution of the model, in the method for optimally promoting decisions and the computer program product thereof provided according to the embodiments of the present invention, by utilizing the optimal solution and the worst solution, the optimal information can be quickly obtained, and effects of reducing computing resources and a computing time are achieved. In addition, by automatically adjusting the learning weight vector W, in the method for optimally promoting decisions and the computer program product thereof provided in the embodiments of the present invention, the correctness of the information can be objectively conveyed, and errors caused by past data can be corrected immediately, thereby improving analysis accuracy. That is, according to the present invention, after a non-linear optimization algorithm is made for a large amount of data through artificial intelligence, not only all to-be-decided items can be quantified, but also the accuracy of the optimal information can be really quickly and greatly improved. Therefore, when the present invention is applied to the investment field, not only an investment target with value can be quickly selected, but also an investment combination that is suitable for the property of the investor may be selected by the investor. In this way, investors can make investment decisions by using objective big data.

What is claimed is:

1. A method for optimally promoting decisions, provided to perform a non-linear calculation by a computer to generate optimal information, wherein after acquiring original data of a plurality of sources, the computer performs the non-linear calculation immediately, and the accuracy of the optimal information is improved, and the method for optimally promoting decisions comprises the following steps:
normalizing the original data of the sources as a characteristic set;
selecting a plurality of indicators from the characteristic set to form a decision set, wherein the decision set is one of factors affecting the efficiency of the non-linear calculation and the accuracy of the optimal information;
receiving the decision set and determining whether the original data of the sources that corresponds to the indicators has a change;
correspondingly adjusting a learning weight vector when it is determined that the change has occurred, and obtaining an optimal solution and a worst solution according to the learning weight vector and the decision set, wherein elements in the learning weight vector correspond to the indicators respectively and are substantially between 0 and 1, and a sum of the elements is 1; and
generating the optimal information according to the optimal solution and the worst solution.

2. The method for optimally promoting decisions according to claim 1, wherein the step of receiving the decision set and determining whether the original data of the sources that corresponds to the indicators has a change comprises:
maintaining, when it is determined that the change has not occurred, the optimal solution and the worst solution obtained according to the learning weight vector.

3. The method for optimally promoting decisions according to claim 1, wherein the step of correspondingly adjusting the learning weight vector when it is determined that the change has occurred, to obtain the optimal solution and the worst solution comprises:
performing a one-time overall operation to adjust the learning weight vector.

4. The method for optimally promoting decisions according to claim 1, wherein after the step of selecting a plurality of indicators from the characteristic set to form the decision set, the method further comprises: estimating a risk probability.

5. The method for optimally promoting decisions according to claim 4, wherein the step of estimating a risk probability comprises: defining a machine learning model in response to characteristics of the decision set, to estimate the risk probability more accurately, wherein the machine learning model is a Support Vector Machine (SVM), an artificial neural network (ANN), a Bayes' classifier, a Markov's chain, a hidden Markov model (HMM) or clustering.

6. The method for optimally promoting decisions according to claim 1, wherein the computer is a personal computer or a server.

7. The method for optimally promoting decisions according to claim 1, wherein the original data of the sources comprises at least one of structured data, unstructured data, and semi-structured data.

8. A computer program product for optimally promoting decisions, wherein after being loaded by a computer to perform a non-linear calculation, the computer program product generates optimal information, and the accuracy of the optimal information is improved, and the computer program product comprises:
an original data acquisition module, acquiring original data of a plurality of sources;
a normalization module, normalizing the original data of the sources as a characteristic set;
a characteristic selection module, selecting a plurality of indicators from the characteristic set to form a decision set, wherein the decision set is one of factors affecting the efficiency of the non-linear calculation and the accuracy of the optimal information;
a learning weight vector module, receiving the decision set and determining whether the original data of the sources that corresponds to the indicators has a change, correspondingly adjusting a learning weight vector when the change has occurred, and obtaining an optimal solution and a worst solution according to the learning weight vector and the decision set, wherein elements in the learning weight vector correspond to the indicators respectively and are substantially between 0 and 1, and a sum of the elements is 1; and
an optimization module, generating the optimal information according to the optimal solution and the worst solution.

9. The computer program product for optimally promoting decisions according to claim 8, wherein when the learning weight vector module determines that the change has not occurred, the optimal solution and the worst solution obtained according to the learning weight vector are maintained.

10. The computer program product for optimally promoting decisions according to claim 8, wherein when the learning weight vector module determines that the change has occurred, a one-time overall operation is performed to adjust the learning weight vector.

11. The computer program product for optimally promoting decisions according to claim 8, the computer program product further comprising a risk estimation module, configured to receive the decision set outputted by the characteristic selection module, and then substitute the decision set into a defined machine learning model to estimate a risk probability.

12. The computer program product for optimally promoting decisions according to claim 11, wherein the optimization module generates the optimal information according to the optimal solution, the worst solution, and the risk probability.

13. The computer program product for optimally promoting decisions according to claim 11, wherein the machine learning model is defined in response to characteristics of the decision set, to estimate the risk probability more accurately, wherein the machine learning model is a Support Vector Machine (SVM), an artificial neural network (ANN), a Bayes' classifier, a Markov's chain, a hidden Markov model (HMM) or clustering.

14. The computer program product for optimally promoting decisions according to claim 8, wherein the original data of the sources comprises at least one of structured data, unstructured data, and semi-structured data.
